(19) United States
(12) Patent Application Publication
(10) Pub. No.: US 2008/0037260 A1
(43) Pub. Date: Feb. 14, 2008

(54) ILLUMINANT DEVICE FOR PROJECTING SYSTEM

(75) Inventor: Liang-Shu WANG, Taipei (TW)

Correspondence Address: BIRCH STEWART KOLASCH & BIRCH, PO BOX 747, FALLS CHURCH, VA, 22040-0747, US

(73) Assignee: COMPAL COMMUNICATIONS, INC., Tapei (TW)

(21) Appl. No.: 11/836,007

(22) Filed: Aug. 8, 2007

(30) Foreign Application Priority Data
Aug. 8, 2006 (TW) 095129039

(51) Int. Cl. F21V 13/04; F21V 7/06

(52) U.S. Cl. 362/308; 362/296

(57) ABSTRACT

The invention provides an illuminant device for a projecting system. The illuminant device includes an illuminant unit, a diffusing element, and a concave mirror. The illuminant unit has a plurality of illuminants which are closely disposed. The diffusing element has an incident surface opposite to the illuminant unit and an emergent surface for a diffused light radiating therefrom. The concave mirror has a reflective surface used for condensing at least a part of the light radiated by the illuminant unit on the incident surface of the diffusing element.

### BACKGROUND OF THE INVENTION

1. Field of the Invention

The invention relates to an illuminant device; in particular, to an illuminant device for a projecting system.

2. Description of the Prior Art

Because of the prevalence of handheld electronic devices, such as mobile phones and PDAs, all manufacturers have tried their best to integrate more functions, such as a camera or a stereo, into the handheld electronic devices to increase the additional value of the products.

The volume of each component in a conventional projecting system is used to be huge. Therefore, if the projecting system is supposed to be integrated into a handheld electronic device, the components in the projecting system, such as an illuminant device, must be renewedly designed to scale down their volume.

Referring to FIG. 1, a conventional illuminant device includes an illuminant unit 11, a concave mirror 12 for condensing the lights radiated from the illuminant unit 11, and a diffusing element 13 for diffusing the condensed lights. The illuminant unit 11 and the concave mirror 12 are usually in a one-on-one way to reach the best light-condensing effect.

However, the one-on-one way will cause a problem of lacking of lightness. In order to solve the above-mentioned problem, the illuminant 11 and the concave mirror 12 in a many-on-many way is proposed. However, this will increase the volume of the illuminant device violating the requirement of reducing volume of a handheld electronic device.

### SUMMARY OF THE INVENTION

A scope of the invention is to provide an illuminant device for enhancing the lightness and reducing the volume of the illuminant device.

An illuminant device for a projecting system based on the invention includes an illuminant unit, a diffusing element, and a concave mirror. The illuminant unit has a plurality of illuminants which are closely disposed. The diffusing element has an incident surface opposite to the illuminant unit and an emergent surface for the diffused light radiating therefrom. The concave mirror has a reflective surface used for condensing at least a part of the light radiated by the illuminant unit on the incident surface of the diffusing element.

The illuminant unit with a plurality of illuminants is applied to the illuminant device of the invention to reach the many-on-one form of the illuminants and the concave mirror. As a result, the lightness becomes higher apparently, and the volume of the illuminant device is reduced as well. Namely, the invention provides an excellent solution for integrating the projecting system into the handheld electronic device.

The advantage and spirit of the invention may be understood by the following recitations together with the appended drawings.

### BRIEF DESCRIPTION OF THE APPENDED DRAWINGS

FIG. 1 is a schematic diagram of a conventional illuminant device.

FIG. 2 is a schematic diagram of a conventional illuminant device.

FIG. 3 is a schematic diagram of an illuminant device of the first preferred embodiment based on the invention.

FIG. 4 is a schematic diagram of a light-emitting diode (LED) with a multi-die packaged structure as an illuminant unit based on the invention.

FIG. 5 is a schematic diagram of an integration rod of the first preferred embodiment based on the invention.

FIG. 6 is a schematic diagram of a semi-elliptic concave mirror of the first preferred embodiment based on the invention.

FIG. 7 is a schematic diagram of an illuminant device of the second preferred embodiment based on the invention.

FIG. 8 is a schematic diagram of a parabolic concave mirror of the second preferred embodiment based on the invention.

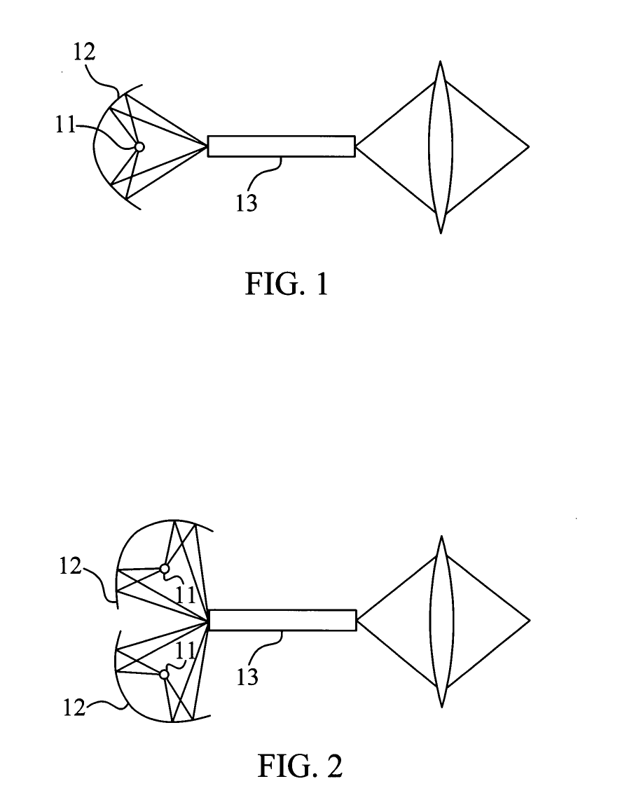

### DETAILED DESCRIPTION OF THE INVENTION

Before the invention is described in detail, it should be noted that the similar devices are represented by the same serial number in the following description and figures.

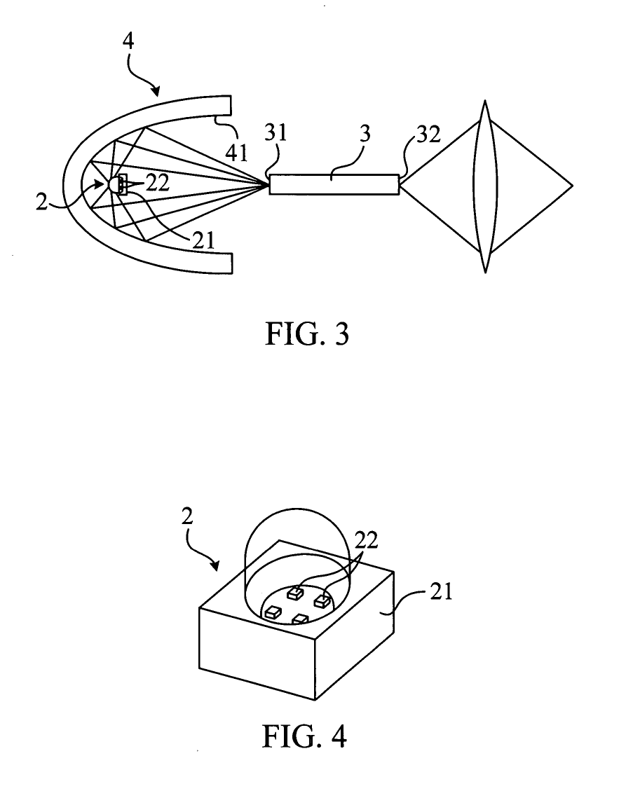

Referring to FIG. 3, an illuminant device of the first preferred embodiment based on the invention includes an illuminant unit 2, a diffusing element 3, and a concave mirror 4.

In order to enhance the lightness of the illuminant device, but not to increase the volume of the illuminant device, a new type of illuminant unit which has the advantages of high lightness and small volume is thus used in the embodiment. As shown in FIG. 4, the illuminant unit is a light-emitting diode (LED) unit with a multi-die packaged structure. A plurality of light-emitting diode dies 22 are separately arranged in the same direction and disposed on a mount 21, wherein each of the light-emitting diode dies 22 can be an illuminant capable of being independently driven to radiate light.

Because the LED unit with a multi-die packaged structure has the advantages of high lightness and small volume, and an interval between the two LED dies 22 is very small (less than 3 mm), the LED unit can be considered as a point illuminant approximatively. Thus, the purpose of enhancing the lightness and reducing the volume can be reached at the same time by applying it as illuminant unit 2 in the invention.

In addition, in practical applications, a light bulb with a plurality of filaments or a high pressure mercury lamp capable of simultaneously inducing a plurality of electric arcs can be adopted as well.

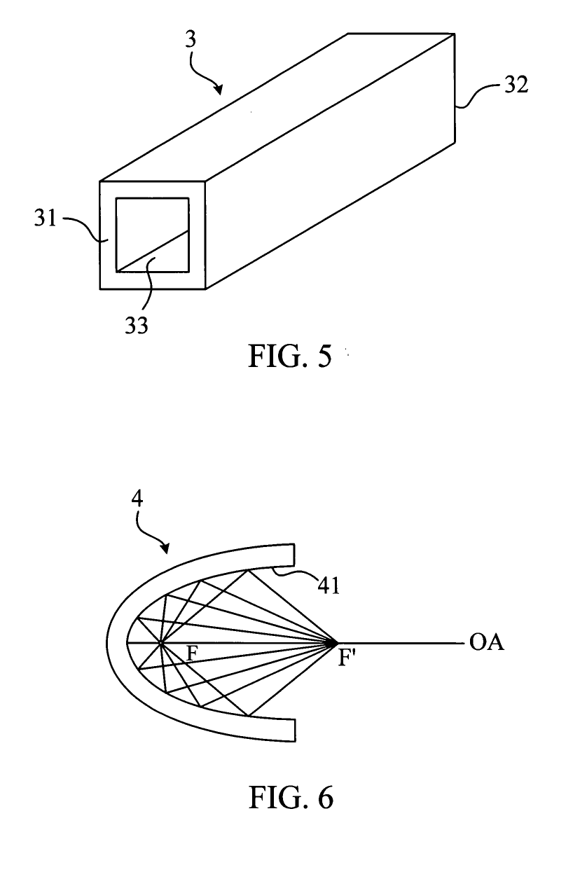

Referring to FIG. 3 and FIG. 5, the diffusing element 3 is an integration rod in this embodiment. The integration rod is used for diffusing the lights radiated from the illuminant so that the diffused lights can be applied to the projecting device in which the light uniformity is highly demanded. In the embodiment, a hollow integration rod with a rectangular cross-section is taken as an example of the integration rod. The hallow integration rod has a channel 33 extending from an incident surface 31 along the direction of an optical axis to an emergent surface 32. While facing the illuminant unit 2, the incident surface 31 receives the lights radiated from the illuminant unit 2. After the lights are incident from the incident surface 31 to the channel 33, a plurality of times of light reflection occur on the wall of the integration rod around the channel 33 to have the effect of light uniformity.

In practical applications, the integration rod can be replaced by other integration rods which meet the requirement of light uniformity. It should not be limited by the rectangle hollow integration rod shown in the embodiment discussed above.

The concave mirror 4 has a semi-elliptic reflective surface 41 and is disposed on one side of the illuminant unit 2 opposite to the diffusing element 3, Because the lights radiated by the illuminant unit 2 are randomly radiated, the reflective surface 41 is required to condense the lights radiated by the illuminant unit 2 on the incident surface 31 of the diffusing element 3.

Referring to FIG. 3 and FIG. 6, because the semi-elliptic reflective surface 41 has two focuses, F and F′, on the optical axis OA, the light radiated from one focus F(F′) will be condensed to another focus F′(F) via the reflection of the reflective surface 41. With this characteristic, the LED with a multi-die packaged structure of the illuminant unit 2 in the embodiment is considered as a point illuminant and disposed on the focus F near the reflective surface 41. And, the incident surface 31 of the diffusing element 3 is disposed on the focus F′ far from the reflective surface 41. In this way, most lights radiated from the illuminant unit 2 will be condensed on the incident surface 31 of the diffusing element 3 via the reflection of the reflective surface 41.

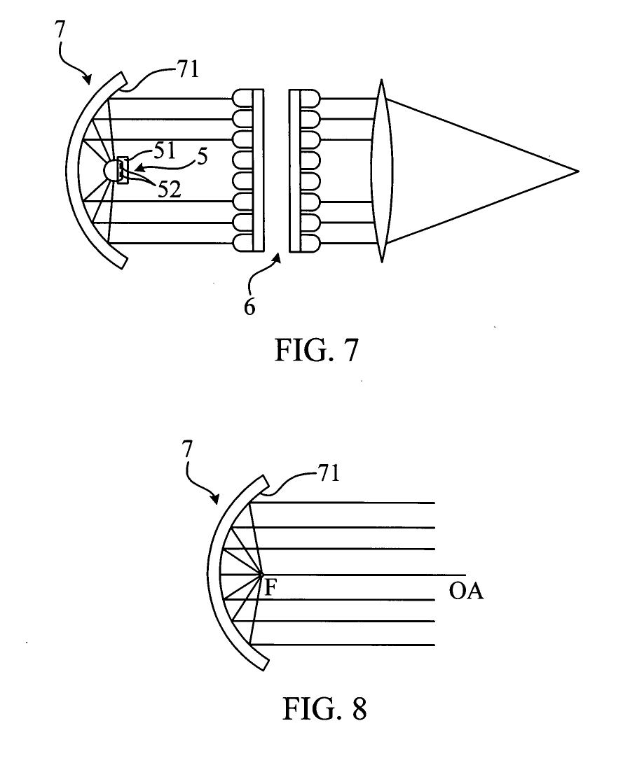

Referring to FIG. 7 and FIG. 8, similar to the first preferred embodiment, the second preferred embodiment based on the invention includes an illuminant unit 5, a diffusing element 6, and a concave mirror 7. The structure and effect of the illuminant unit 5 are the same as that of the illuminant unit 2 in the first preferred embodiment, so the detail is not further described hereof.

The diffusing element 6 is a pair of lens array, and its function, to let incident lights be uniform, is similar to the integration rod used in the first preferred embodiment. However, the operating principle is different between the diffusing element 6 and the integration rod. For the integration rod, the focused lights are received by the incident surface of the integration rod, and the diffused lights radiated from the emergent surface have a divergent angle. For the lens array, the lens array receives collimated lights and radiates collimated lights after the diffusing process.

The concave mirror 7 has a parabolic reflective surface 71 and the concave mirror 7 is disposed at the side of the illuminant unit 5 opposite to the diffusing element 6. Because the parabolic surface has a focus F on the optical axis OA, after the reflection of the reflective surface 71, the lights radiated from the focus F will emit along the optical axis OA in parallel. With this characteristic, the light-emitting diode (LED) unit with a multi-die packaged structure, i.e. the illuminant unit 5 in the embodiment, can be regarded as a point illuminant which is disposed on the focus F of the reflective surface 71. In this way, most lights radiated from the illuminant unit 5 will emit in parallel lights along the optical axis OA toward the lens array of the diffusing element 6 via the reflection of the reflective surface 71.

In conclusion, compared to the one-on-one or many-on-many form of the illuminant and the concave mirror in conventional projecting systems, the illuminant unit with a plurality of illuminants is used in the illuminant devices of the first and the second preferred embodiment to achieve the many-on-one form of the illuminant and the concave mirror. Obviously, the present invention produces higher lightness and reaches the requirement of reducing the volume of an illuminant device. The invention provides a good solution for integrating the projecting system into the handheld electronic device.

With the above example and explanation, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An illuminant device, comprising:
an illuminant unit having a plurality of illuminants which are separately arranged in the same direction and are closely disposed;
a diffusing element having an incident surface opposite to the illuminant unit and an emergent surface wherein diffused light is radiated therefrom; and
a concave mirror having a reflective surface used for condensing at least a part of the light radiated by the illuminant unit on the incident surface of the diffusing element.

2. The illuminant device of claim 1, wherein an interval between the two illuminants is less than 3 mm.

3. The illuminant device of claim 2, wherein the diffusing element is an integration rod having the incident surface and the emergent surface opposite to the incident surface, and the reflective surface of the concave mirror is a semi-elliptic surface having a first focus and a second focus, and wherein the illuminant unit is located at the first focus, and the incident surface of the integration rod is substantially located at the second focus.

4. The illuminant device of claim 2, wherein the diffusing element is a cylinder lens array, the reflective surface of the concave mirror is a paraboloid, and the illuminant unit is located at a focus of the paraboloid.

5. The illuminant device of claim 1, wherein the illuminant unit is a light-emitting diode (LED) unit with a multi-die packaged structure, and the light-emitting diode has a plurality of light-emitting diode dies as the illuminants.

6. The illuminant device of claim 5, wherein the diffusing element is an integration rod having the incident surface and the emergent surface opposite to the incident surface, and the reflective surface of the concave mirror is a semi-elliptic surface having a first focus and a second focus, and wherein the illuminant unit is located at the first focus, and the incident surface of the integration rod is substantially located at the second focus.

7. The illuminant device of claim 5, wherein the diffusing element is a cylinder lens array, the reflective surface of the concave mirror is a paraboloid, and the illuminant unit is located at a focus of the paraboloid.

8. The illuminant device of claim 1, wherein the diffusing element is an integration rod having the incident surface and the emergent surface opposite to the incident surface, and the reflective surface of the concave mirror is a semi-elliptic surface having a first focus and a second focus, and wherein the illuminant unit is located at the first focus, and the incident surface of the integration rod is substantially located at the second focus.

9. The illuminant device of claim 1, wherein the diffusing element is a cylinder lens array, the reflective surface of the concave mirror is a paraboloid, and the illuminant unit is located at a focus of the paraboloid.
